(19) United States
(12) Patent Application Publication
(10) Pub. No.: US 2011/0145378 A1
(43) Pub. Date: Jun. 16, 2011

(54) OPERATING METHOD OF NETWORK NODE OF NETWORK WITH TREE STRUCTURE BASED ON DISTRIBUTED ADDRESS ASSIGNMENT AND NETWORK FORMING METHOD

(75) Inventors: Jongjun PARK, Daejeon (KR); Hoon Jeong, Daejeon (KR); So-Young Hwang, Pusan (KR); Bong Soo Kim, Daejeon (KR); Seong-Soon Joo, Daejeon (KR); Jong-Suk Chae, Daejeon (KR)

(73) Assignee: ELECTRONICS AND TELECOMMUNICATIONS RESEARCH INSTITUTE, Daejeon (KR)

(21) Appl. No.: 12/822,295

(22) Filed: Jun. 24, 2010

(30) Foreign Application Priority Data
Dec. 10, 2009 (KR) 10/2009-0122459

(51) Int. Cl. G06F 15/173; G06F 15/177

(52) U.S. Cl. 709/222; 709/238

(57) ABSTRACT

Provided is a method for operating a network node in a specific cluster of a tree-structured network based on distributed address assignment. In the method, a non-registered node is detected. A routing depth of the network node is determined. When the determined routing depth corresponds to a reference value, a sub cluster using a cluster address is generated, and the detected non-registered node is registered as a child node in the generated sub cluster using an internal address.

### CROSS-REFERENCE TO RELATED APPLICATIONS

This U.S. non-provisional patent application claims priority under 35 U.S.C. §119 of Korean Patent Application No. 10-2009-0122459, filed on Dec. 10, 2009, the entire contents of which are hereby incorporated by reference.

### BACKGROUND OF THE INVENTION

The present invention disclosed herein relates to a network, and more particularly, to an operating method of a network node of a network with a tree structure based on distributed address assignment and a network forming method.

With development of network technologies, studies are being actively conducted on Ubiquitous Sensor Network (USN). USN realizes real-time collection and building of information on objects and environments.

In USN, the addresses of the network nodes are assigned based on Distributed Address Assignment (DAA) or Centralized Address Assignment (CAA). DAA represents an address assignment method in which an address assignment function of a network node is distributed over a network. For example, a plurality of network nodes have the address assignment authority. CAA represents an address assignment method in which a coordinator node or a sink node of a network has the address assignment authority.

USN has a mesh topology or a tree topology. The mesh topology has a configuration in which one network node can communicate with a plurality of network node. The tree topology has a configuration in which one network node can communicate with a parent node and a child node. That is, when first and second nodes communicate with each other in the mesh topology, the first and second nodes can communicate with each other directly. On the other hand, in the tree topology, when the branches of the first and second network nodes are different from each other, the communication is performed via the uppermost node (for example, a coordinator node or a sink node).

### SUMMARY OF THE INVENTION

The present invention provides improved scalability to a network of a tree structure based on distributed address assignment.

The present invention also reduces address waste in a tree-structured network based on distributed address assignment.

Embodiments of the present invention provide methods for operating a network node in a specific cluster of a tree-structured network based on distributed address assignment including: detecting a non-registered node; determining a routing depth of the network node; and generating a sub cluster using a cluster address and registering the detected non-registered node as a child node in the generated sub cluster using an internal address, when the determined routing depth corresponds to a reference value.

In some embodiments, when the determined routing depth is smaller than the reference value, the method may further include registering the detected non-registered node as a child node in the specific cluster using the internal address.

In other embodiments, the reference value may correspond to a maximum depth of the specific cluster.

In still other embodiments, the method may further include operating as a sub coordinator corresponding to the generated sub cluster.

In even other embodiments, when the determined routing depth corresponds to the reference value, the method may further include transmitting a cluster request corresponding to the detected non-registered node to a parent node.

In yet other embodiments, when the determined routing depth corresponds to the reference value, the method may further include receiving a cluster address according to the transmitted cluster request from the parent node.

In other embodiments of the present invention, methods for operating a coordinator node of a tree-structured network based on distributed address assignment includes: dividing addresses assigned to the network into cluster addresses and internal addresses; registering a child node using the internal addresses; and selecting a free address from the cluster addresses and transmitting the selected free cluster address to the child node, when a cluster request is received.

In some embodiments, the method may further include setting a child node receiving the selected free cluster address to a routing path corresponding to the selected free cluster address.

In other embodiments of the present invention, methods for forming a tree-structured network based on distributed address assignment includes: dividing addresses assigned to the network into cluster addresses and internal addresses; generating a main cluster, based on the internal addresses; and generating a sub cluster using the cluster addresses when a non-registered node is detected after generation of the main cluster.

In some embodiments, the method may further include registering the detected non-registered node in the generated sub cluster using the internal addresses.

In other embodiments, the method may further include generating a second sub cluster using on the cluster addresses when a second non-registered node is detected after generation of the generated sub cluster.

In still other embodiments, the method may further include setting the network node having detected the non-registered node as a sub coordinator node of the generated sub cluster.

In even other embodiments, the generating of the sub cluster using the cluster addresses may include: selecting a free address from the cluster addresses; and assigning the selected free cluster address to the sub cluster.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a diagram illustrating a topology of a sensor network according to an embodiment;

FIG. 2 is a diagram illustrating an exemplary network configured with sensor nodes according to the topology of FIG. 1 according to an embodiment;

FIG. 3 is a diagram illustrating an example of registering all sensor node of FIG. 2 in the sensor network;

FIG. 4 is a block diagram illustrating a network address according to an embodiment;

FIG. 5 is a block diagram illustrating a network based on the network address of FIG. 4;

FIG. 6 is a block diagram illustrating a sensor network based on generation of a dynamic cluster of FIG. 5;

FIG. 7 is a flowchart illustrating a process of generating the sensor network of FIG. 6;

FIG. 8 is a flowchart illustrating an operation of a network node of the sensor network described with reference to FIGS. 4 through 7;

FIG. 9 is a flowchart illustrating an operation of a coordinator node of the sensor network described with reference to FIGS. 4 through 7;

FIG. 10 is a flowchart illustrating a method for forming (or expanding or updating) the sensor network described with reference to FIGS. 4 through 7;

FIG. 11 is a diagram illustrating a sensor system including the sensor network of FIG. 6 according to a first embodiment; and

FIG. 12 is a diagram illustrating a sensor system including the sensor network of FIG. 6 according to a second embodiment.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Hereinafter, embodiments according to the technical spirit of the present invention will be described in detail with reference to a sensor network. However, the technical spirit should not be construed as limited only to application to the sensor network. A sensor network according to an embodiment will be assumed to be a network with a tree structure based on Distributed Address Assignment (DAA). For example, a sensor network according to an embodiment will be assumed to be an IEEE 802.15.4 ZigBee network. However, the technical spirit of the present invention should not be construed as limited to the network with the tree structure based on DAA or the IEEE 802.15.4 ZigBee network.

Hereinafter, a network according to an embodiment will be referred to as a term ‘network’ or ‘sensor network’. Also, network nodes according to an embodiment will be referred to as a term ‘sensor node’ or ‘network node’. A parent node or a superior node indicates one of network nodes, which is used as the opposite concept to that of a child node or an inferior node.

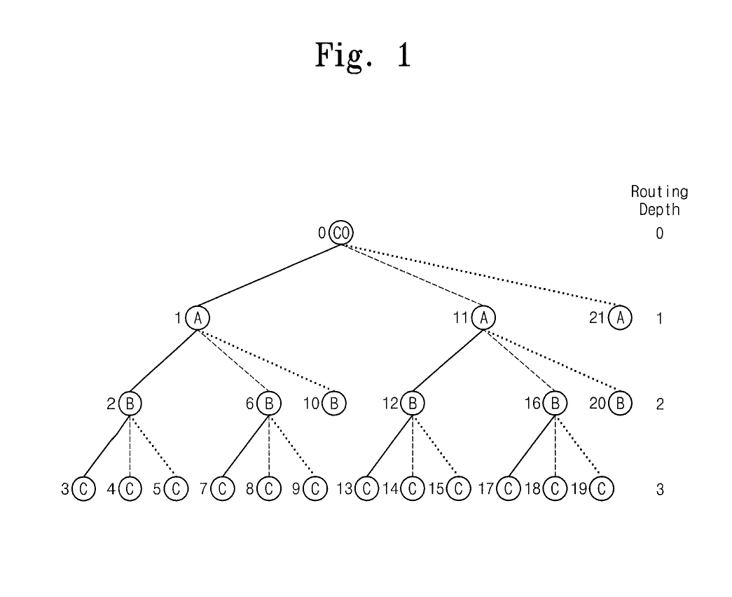

FIG. 1 is a diagram illustrating a topology of a sensor network according to an embodiment. Referring to FIG. 1, the sensor network may include a topology of a tree structure.

A network (for example, ZigBee network) with a tree structure based on the distributed address assignment may be defined using three parameters. The three parameters defining a network are described in Table 1 below.

TABLE 1

| Parameter | Meaning |
|---|---|
| Lm | Max Depth |
| Cm | Max Child |
| Rm | Max router |

A routing depth of the uppermost node (for example, a coordinator node or a sink node) is 0 in a tree structure. The network nodes having a routing depth of 1 are connected to the uppermost node through one hop. That is, the routing depth of inferior nodes of the uppermost node is 1. The network nodes having a routing depth of 2 are connected to the uppermost node through two hops. That is, the routing depth of inferior nodes of the uppermost node is 2. Thus, it can be understood that the routing depth represents how many hops are required for a network node to be connected to the uppermost node or what order in the inferior nodes the network node is from the uppermost node.

The max depth Lm represents a max routing depth that a network can have. For example, if the max depth Lm is 2, the network may have network nodes having a routing depth of 0 to 2. That is, the uppermost node having a routing depth of 0, inferior nodes having a routing depth of 1, and inferior nodes having a routing depth of 2 inferior to the inferior nodes may be registered in a network.

The max child Cm represents the maximum number of inferior nodes that a network node can have. That is, if the max child Cm is 3, a network node can have three inferior nodes.

The max router Rm represents the number of routing nodes among inferior nodes of a network node. Nodes except routing nodes from inferior nodes of a network are end devices. For example, if the max child Cm is 3, and the max router Rm is 2, then the network node may have three child nodes, two of the three child nodes are routing nodes, and the other node is an end device.

For example, the routing node is a Full Function Device (FFD), and the end device is a Reduced Function Device (RFD). The routing node may be configured to perform an operation of a typical sensor node such as sensing, and additionally to perform a routing function between network nodes. That is, the routing node may deliver a message from a parent node to a child node, and a message from the child node to the parent node.

The end device may not have a routing function, and may not have a communication function with another end device. That is, the end device may not be used as a parent node of another network node, and may not be used as a child node of another end device. The end device is registered as a child node of a routing node, and does not have a child node.

A network is generated based on the max depth Lm, the max child Cm, and the max router Rm. For example, a network having a max depth Lm of 3, a max child Cm of 3, and a max router Rm of 2 is shown in FIG. 1.

The uppermost node CO is called a coordinator node or a sink node. The coordinator node may be connected to an external network (for example, Broadband Convergence Network (BcN) through a gateway. The routing depth of the coordinator CO is 0. The coordinator CO may have a number of child nodes A corresponding to the max child Cm.

The child nodes A of the coordinator CO of the number corresponding to the max router Rm are routing nodes. Other nodes are end devices.

The routing depth of the child nodes A of the coordinator node CO is 1. That is, the child nodes A are connected to the coordinator node CO through one hop. The network nodes A having a routing depth of 1 has child nodes B according to the max child Cm and the max router Rm, respectively. The routing depth of the child nodes 8 is 2. That is, the child nodes B are connected to the coordinator node CO through two hops.

The network nodes B having a routing depth of 2 have child nodes C based on the max child Cm and the max router Rm, respectively. The routing depth of the child nodes C is 3. That is, the child nodes C are connected to the coordinator CO through three hops. The max depth Lm is being set to 3. Accordingly, the network nodes C having a routing depth of 3 do not have child nodes.

As shown in FIG. 1, the parent nodes have the child nodes that are connected using a solid line, a broken line, and a dotted line. A child node connected using the solid line is defined as a first child node. A child node connected using the broken line is defined as a second child node. A child node connected using the dotted line is defined as a third child node. The forms of the line connecting between the parent nodes and the child nodes are divided for convenience of explanation, and should not be construed as representing different communication means or methods.

In FIG. 1, the reference numerals corresponding to the respective network nodes represent addresses. The address of the coordinator CO is defined as 0. The addresses of the child nodes of the coordinator node CO are assigned in order from the first child node and the child nodes thereof to the third node and the child nodes there of. As shown in FIG. 1, the address of the first child node A of the coordinator CO is 1, the address of the first child node thereof is 2, and the address of the first child node C thereof is 3. That is, the addresses are sequentially assigned from the coordinator CO to the first child nodes.

After the assignment of the addresses from the coordinator CO to the first child nodes are completed, an address is assigned to an inferior node having the deepest routing depth. The network node C having a routing depth of 3 and an address of 3 does not have a child node. Accordingly, the second and third node child nodes C of the network node B having a routing depth of 2 and an address of 2 are assigned with the addresses 4 and 5, respectively.

Addresses are sequentially assigned to the second child node B of the network node A having a routing depth of 1 and an address of 1, the inferior nodes thereof, and the third child node B.

Addresses are sequentially assigned to the second child node A of the coordinator node CO having a routing depth of 0 and an address of 0, the inferior nodes thereof, and the third child node A.

As described above, if the max depth LM, and the max child CM, and the max router Rm of the network are defined, a network having a topology and an address as described in FIG. 1 is generated. That is, the addresses assigned to the network nodes are not determined by the registration order on the network or by the coordinator, but are determined by the locations of the registered network nodes on the topology.

For example, it is assumed that a non-registered network node is connected to a network node A having a routing depth of 1 and an address of 1. As shown in FIG. 1, nodes connected to the network node having the address of 1 are determined to be assigned with the addresses 2, 6 and 10. Accordingly, when the non-registered node is connected to the network node A, one of the addresses 2, 6 and 10 is assigned to the non-registered node connected to the network node A having the address of 1.

If the fist child node B is connected, the network node A having the address 1 assigns the address 2 to the first child node B. If the second child node B is connected, the network node A having the address 1 assigns the address 6 to the second child node B. If the third node B is connected, the network node A having the address 1 assigns the address 10 to the third child node B. Even before all the inferior nodes of the first child node B having the address 2 are registered, it is possible for the network node having the address 1 to assign the address 6 to the second child node B.

As described above, the address of the child node is assigned by the parent node. That is, the addresses are assigned to the network nodes based on the distributed address assignment.

The function Cskip(d) can be expressed as Equation (1) below.

$$Cskip ( d ) = 1 + Cm \cdot ( Lm - d - 1 ) , if Rm = 1 \\ Cskip ( d ) = \frac{1 + Cm - Rm - Cm \cdot {Rm}^{Lm - d - 1}}{1 - Rm} , if Rm \neq 1 \qquad ( 1 )$$

It can be understood that the function Cskip(d) represents the sum of the number of network nodes (more particularly, routing nodes) corresponding to a routing depth of ‘d+1’ and the total child nodes thereof. That is, the function Cskip(0) represents the sum of the number of the network node having a routing depth of 1 and the inferior nodes thereof. In FIG. 1, the max depth Lm is 3, the max child Cm is 3, and the max router is 2. Accordingly, Cskip(0) is 10. As shown in FIG. 1, the addresses of the network node A having a routing depth of 1 and an address of 1 and the inferior nodes thereof correspond to the addresses 1 to 10. That is, the sum of the number of the network node A having a routing depth 1 and an address of 1 and the inferior nodes is 10.

Similarly, the addresses of the network node A having a routing depth of 1 and an address of 11 and the inferior nodes thereof correspond to the addresses 11 to 20. That is, the sum of the network node A having a routing depth of 1 and an address of 11 and the inferior nodes thereof is 10.

Since the topology and the address are determined based on the max depth Lm, the max child Cm, and the max router Rm, the maximum number of the addresses of the network can be calculated based on the max depth Lm, the max child Cm, and the max router Rm. The maximum number of the addresses of the network can be expressed as Equation (2) below.

MaxAddress=Cskip(0)×Rm+Cm−Rm+1 (2)

Cskip(0) represent the sum of the number of the network node A having a routing depth of 1 and the child nodes thereof. Accordingly, the multiply of Cskip(0) and the max router Rm represents the sum of the number of the router nodes of the child nodes of the coordinator node CO and the child nodes thereof. If the number (Cm−Rm) of the end devices among the child nodes of the coordinator node CO is added to the above multiply, and the number of the coordinator node CO, 1 is added, the maximum number of the addresses of the network (or the maximum number of the network nodes) is calculated. Cskip(0) is 10, the max router Rm is 2, and the max child Cm is 3. Accordingly, the maximum number of the addresses is 22. Referring to FIG. 1, the network nodes are described as having the addresses 0 to 21. That is, 22 network nodes constitute a network in FIG. 1.

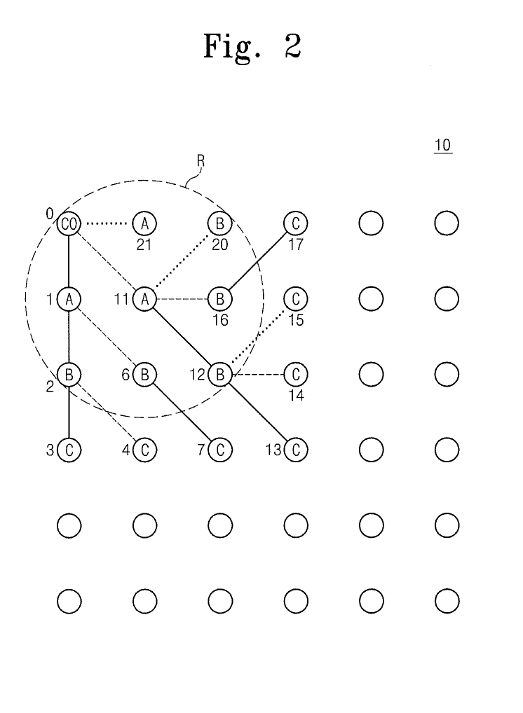

FIG. 2 is a diagram illustrating a sensor network 10 configured with sensor nodes according to the topology of FIG. 1 according to an embodiment. Referring to FIG. 2, the sensor nodes are arranged in a matrix type. For example, the sensor nodes are assumed to perform wireless communication using a wireless communication means.

According to the performance of the communication means, the sensor nodes have a communicable range. For example, the greater the amount of power is distributed to the communication means, and the more the cost increases, the more the communicable range of the sensor nodes increases.

The sensor network 10 includes sensor nodes consuming low cost and low energy. The communicable range of one sensor node can not cover the entire sensor network 10. Accordingly, sensor nodes out of the communicable range of the coordinator node CO may communicate with the coordinator node CO through other sensor nodes, i.e., multihop.

For example, a communicable range R of the second child node A (address 11) of the coordinator node CO is shown in FIG. 2. Network nodes of the sensor networks 10 are assumed to have the same communicable range R, respectively.

As described with reference to FIG. 1, if the max depth Lm, the max child Cm, and the max router Rm are set, the topology and addresses of the network are determined. The respective sensor nodes have the communicable range R. Accordingly, all the network nodes having the addresses 1 to 21 in FIG. 1 are not registered in the network.

As described with reference to FIG. 1, the sensor network 10 having a max depth Lm of 3, a max child Cm of 3, and a max router Rm of 2 is described in FIG. 2.

Referring to the sensor network 10 in FIG. 2, the network nodes corresponding to the addresses 5, 8 to 10, and 18 and 19 have not been registered in the sensor network. The first and second child nodes of the addresses 2 and 6 are connected to the network node A of the address 1. However, there is no non-registered node to be connected to the third child node of the address 10 in the network node A of the address 1. Accordingly, the address to be assigned to the third child node (address 10) of the network node A of the address 1 is wasted.

Similarly, the address to be assigned to the third child node (address 5) of the network node B of the address 2, the addresses to be assigned to the second and third child nodes (addresses 8 and 9) of the network node B of the address 6, and the addresses to be assigned to the second and third child nodes of the network node B of the address 16 are wasted.

That is, the maximum number of the addresses of the sensor network 10 having a max depth Lm of 3, a max child Cm of 3, and a max router Rm of 2 is 22, but the number of the registered network nodes is 16. That is, six addresses are wasted in the sensor network 10.

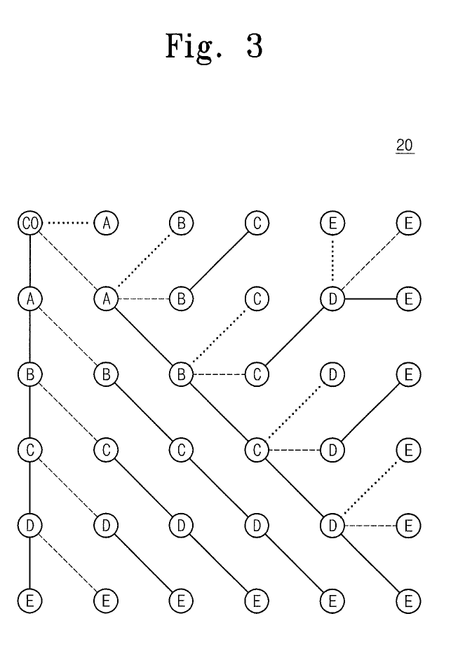

To register all the sensor nodes in FIG. 2 on the sensor network, the network nodes C having a routing depth of 3 are configured to have child nodes as well. That is, the max depth Lm of the sensor network 10 has to be increased. A sensor network 20 on which all sensor nodes are registered is shown in FIG. 3. Referring to FIGS. 2 and 3, the sensor network 20 may have child nodes D of a routing depth of 4 and child nodes E of a routing depth of 5.

To resister child nodes of a routing depth of 5, the max depth Lm of the sensor network 20 has to be equal to or greater than 5. The maximum number of the addresses of a sensor network having a max depth Lm of 5 may be calculated by referring to Equation 2 above. The number of the addresses of the sensor network having a max depth Lm of 5 is 94. That is, the number of registrable network nodes is 94. On the other hand, the number of the network nodes registered on the sensor network 20 is 36. That is, 58 addresses are wasted in the sensor network 20.

For example, a ZigBee network uses a 16-bit address. The number of assignable addresses by 16-bit address is 2̂16=65,535. The maximum number of the addresses of the sensor network 10 is defined by Equation 2 above. It is assumed that the max child Cm and the max router Rm are fixed to 3 and 2, respectively, and the max depth Lm increases. In this case, the relation between the max depth Lm and the max address is described in Table 2.

TABLE 2

| Max Depth (Lm) | Max Address |
|---|---|
| 4 | 46 |
| 5 | 94 |
| 6 | 190 |
| . . . | . . . |
| 13 | 24574 |
| 14 | 49150 |
| 15 | 98302 |

The maximum number of addresses is a function of Cskip (0). Cskip(0) is a function depending on the square of the max depth Lm with respect to the max router Rm. That is, as the max depth Lm increases, the maximum number of the addresses increases geometrically. As described in Table 2, if the max depth Lm reaches 15, the maximum number of the addresses of the sensor network is 98,302. This is greater than the number of assignable addresses with 16-bit address, 65,535. Accordingly, in a network in which the 16-bit address is used and the max child Cm and the max router Rm are set to 3 and 2, respectively, the max depth Lm is limited to a value smaller than 15.

In brief, the topology described with reference to FIGS. 1 and 2 incurs waste of address, and the max dept Lm is limited. Also, as the max depth Lm increases, the number of wasted addresses increases progressively.

In order to solve the above limitation, the sensor network according to this embodiment divides addresses into a first region and a second region. The sensor network configures a cluster based on addresses of the first region, and provides scalability based on addresses of the second region.

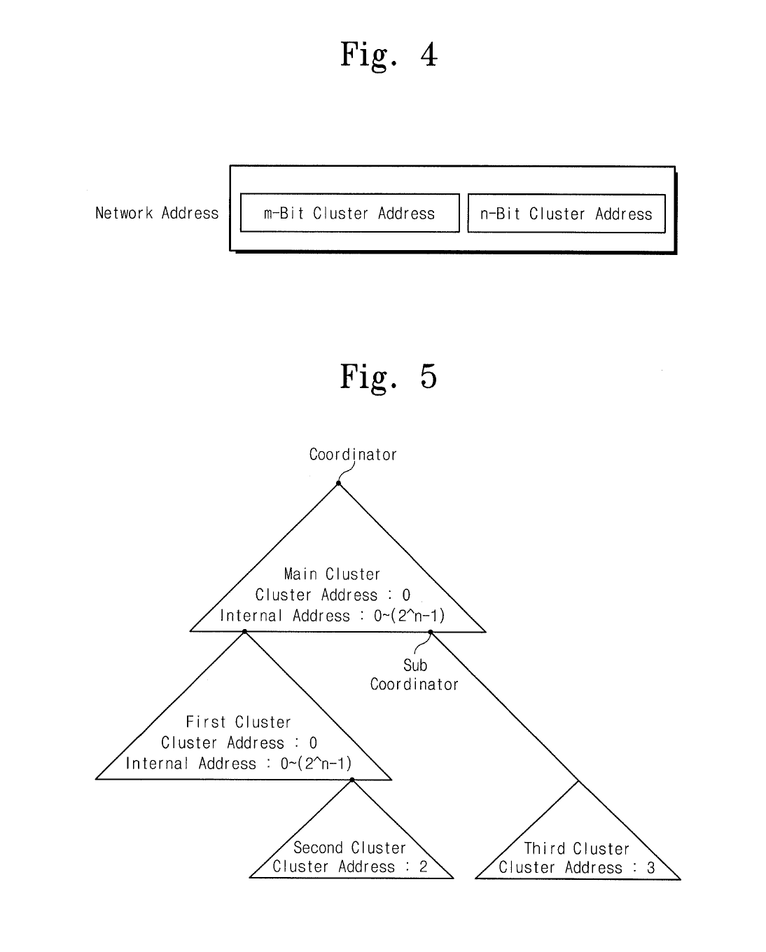

FIG. 4 is a block diagram illustrating a network address according to an embodiment. Referring to FIG. 4, the network address may be divided into a first region (n-bit internal address) and a second region (m-bit cluster address).

FIG. 5 is a block diagram illustrating a network based on the network address of FIG. 4. Referring to FIGS. 4 and 5, a main cluster and sub clusters including first to third cluster are shown.

When a sensor network is generated, the max depth Lm, the max child Cm, and the max router Rm of the network are set. The max depth Lm, the max child Cm, and the max router Rm of the network are set such that maximum number of addresses generated by the max depth Lm, the max child Cm, and the max router Rm of the network is smaller than the number of the addresses that can be assigned by an n-bit internal address. That is, the max depth Lm, the max child Cm, and the max router Rm of the network are the number of network nodes of the sensor network can be recognized by the n-bit internal address. The main cluster is generated based on the max depth Lm, the max child Cm, and the max router Rm of the network.

Even after the main cluster is generated, there may be a non-registered node. For example, as described with reference to FIG. 2, there may be a non-registered node due to the limitation of the max depth Lm of the network. According to an embodiment, a sub cluster is generated based on an m-bit cluster address. The non-registered node is registered in the sub cluster.

If a non-registered node is detected, the network node (hereinafter, referred to as a detection node) having detected the non-registered node may transmit a cluster request to the coordinator node CO. If the cluster request is received, the coordinator node CO may select a free address among the m-bit cluster address. Then, the selected address and cluster response may be transmitted to the detection node.

Based on the cluster response, the detection node may generate a sub cluster. In the sub cluster, the detection node may serve as a sub coordinator. Network nodes in the sub cluster may be recognized by the n-bit internal address. For example, as described with reference to FIGS. 1 and 2, the sub cluster may be generated as a tree structure based on the distributed address assignment. For example, the max depth Lm, the max child Cm, and the max router Rm of the sub cluster may be identical to those of the main cluster. As another example, the max depth Lm, the max child Cm, and the max router Rm of the sub cluster may be set differently from those of the main cluster.

The main cluster and the sub cluster may be recognized by the m-bit cluster address.

That is, based on the cluster address, it may be recognized whether the target node is a node of the main cluster or a node of the sub cluster. Thereafter, based on the internal address, the location of the target node of the corresponding cluster may be recognized.

Since the network nodes in the sub cluster are recognized by the internal address, the maximum number of the addresses of the sub cluster may not be greater than the number of addresses that can be assigned by the n-bit internal address.

In FIG. 5, the coordinator and sub coordinators (or detection nodes) are represented by dots. That is, a first sub cluster may be generated from the detection node of the main cluster. For example, the cluster address of the first sub cluster is described as 1.

A second sub cluster may be generated from the detection node of the first sub cluster. For example, the cluster address of the second sub cluster is described as 2. The third sub cluster may be generated from the detection node of the main cluster. For example, the cluster address of the third sub cluster is described as 3.

As shown in FIG. 5, the sub cluster (for example, second sub cluster) may be generated from the detection node of another sub cluster (for example, first sub cluster). Accordingly, in a range of the m-bit cluster address, the routing depth of the sensor network may be extended by the sub cluster. That is, the scalability of the sensor network can be provided by dynamically generating the sub cluster.

In brief, the max depth Lm, the max child Cm, and the max router Rm are set based on the n-bit internal address. Based on the above max depth Lm, the max child Cm, and the max router Rm, the main cluster may be generated. Thereafter, if a non-registered node is detected, a sub cluster may be generated, and then an address may be assigned to the non-registered node. When the non-registered node is detected, the sub cluster may be dynamically is generated. Accordingly, addresses may be less wasted than the network (10) described with reference to FIGS. 1 through 3.

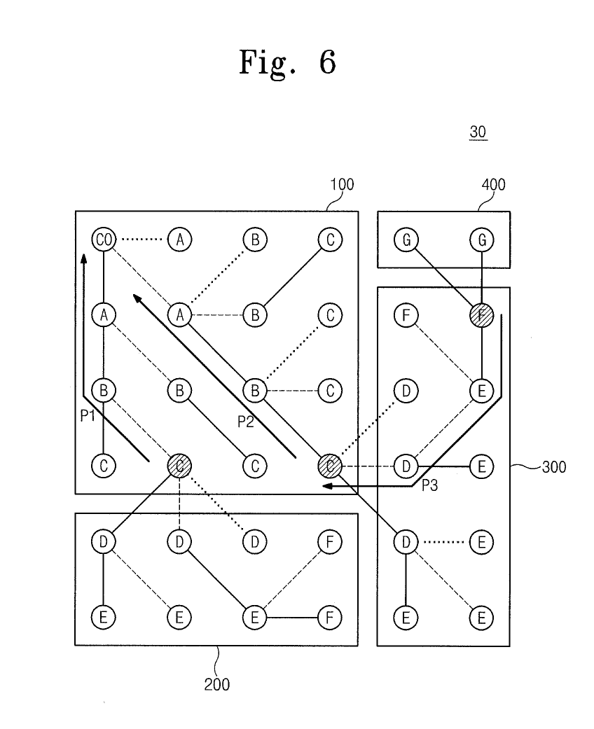

FIG. 6 is a block diagram illustrating a sensor network 30 based on generation of a dynamic cluster of FIG. 5. For example, based on internal address, it is assumed that the max depth Lm is 3, the max child Cm is 3, and the max router Rm is 2. Based on the max depth Lm, the max child Cm, and the max router Rm, a main cluster 100 is generated.

It is assumed that the main cluster 100 and sub clusters 200, 300 and 400 have the same topology and the same maximum number of addresses. That is, the max depth Lm, the max child Cm, and the max routher Rm of the main cluster 100 and the sub clusters 200, 300 and 400 are assumed to be 3, 3, and 2, respectively.

If non-registered nodes are detected, sub clusters 200, 300 and 400 may be generated by detection nodes. The detection nodes (or sub coordinators) are represented by oblique lines.

A detection node C of the first sub cluster 200 may transmit a cluster request to the coordinator node CO through a first path P1. A cluster response may be delivered from the coordinator node CO to the detection node C of the first sub cluster 200 through the inverse path of the first path P1. In this case, nodes on the path through which the cluster response is delivered, that is, the first child node A of the coordinator node CO and the first child node B thereof may be configured to store cluster addresses assigned to the first sub cluster 200. Thereafter, when a message targeting the address of the first sub cluster 200 is received, the nodes on the path may deliver the message to the detection node C of the first sub cluster 200 regardless of the internal address. The detection node C of the first sub cluster 200 may serve as a sub coordinator node of the first sub cluster 200.

Similarly, when a non-registered node is detected, the detection node C of the second sub cluster 300 may transmit a cluster request through a second path P2. A cluster response may be received from the coordinator node CO through the inverse path of the second path P2. In this case, nodes on the path, that is, the second child node A of the coordinator node CO and the first child node B thereof may be configured to store cluster addresses assigned to the second sub cluster 300. The detection node C of the second sub cluster 300 may serve as a sub coordinator node of the second sub cluster 300.

The detection node F of the third sub cluster 400 may transmit a cluster request through a third path P3 and the second path P2. A cluster response may be received from the coordinator node CO through the inverse paths of the second path P2 and the third path P3. Nodes on the path, that is, the second child node A of the coordinator node CO, the first child node B thereof, the first child node C thereof, the second child node D thereof, and the second child node E thereof may be configured to store cluster addresses assigned to the third sub cluster 400. The detection node F of the third sub cluster 400 may serve as a sub coordinator node of the third sub cluster 400.

The maximum number of addresses of the main cluster 100 is 22. In the clusters 100, 200, 300 and 400, the sub coordinator node may be the deepest node of the superior cluster. That is, in superior and inferior clusters, one network node may be duplicated as the sub coordinator node and the deepest node. Accordingly, the maximum number of the addresses of the sub clusters 200, 300 and 400 is 21, respectively. That is, the maximum number of the addresses of the sensor network 30 is 85. Then, 36 network nodes are registered in the sensor network 30. Compared to the sensor network 20 described with reference to FIG. 3, the number of wasted addresses in the sensor network 30 is reduced.

Also, the sensor network 20 described with reference to FIG. 3 has a routing depth of 1 to 5. To extend the routing depth to 6, the maximum number of the addresses of the sensor network 20 has to be increased from 94 to 190.

On the other hand, the sensor network 30 may implement a routing depth of 1 to 9 using the maximum number (85) of the addresses. To extend the routing depth, a sub cluster may be added as an inferior cluster of the third sub cluster 400. That is, if the maximum number of the addresses of the sensor network 30 is increased by 21, the routing depth of the sensor network 30 may be extended to 1 to 12. Accordingly, compared to the sensor network 20 described with reference to FIG. 3, scalability can be provided to the sensor network 30.

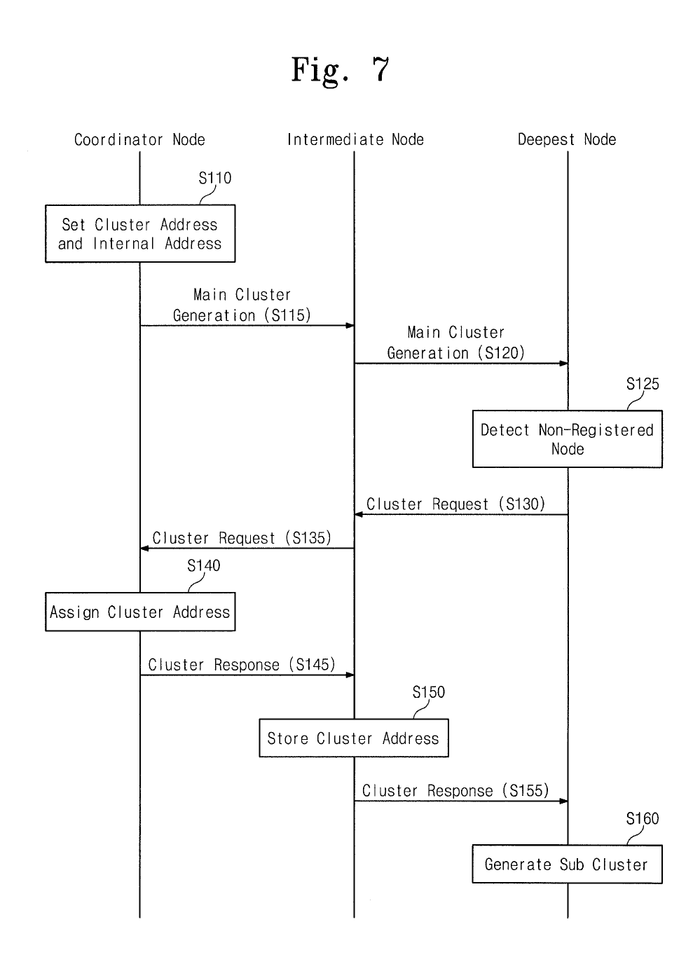

FIG. 7 is a flowchart illustrating a process of generating the sensor network 30 of FIG. 6. Referring to FIGS. 6 and 7, in operation S110, the coordinator node CO may set cluster addresses and internal addresses. For example, a part of addresses assigned to the sensor network 30 is set with the cluster addresses, and the other part of the addresses is set with the internal addresses. Thereafter, based on the internal address, the max depth Lm, the max child Cm, and the max router Rm are determined.

Based on the max depth Lm, the max child Cm, and the max router Rm, a main cluster may be generated. In operation S115, an intermediate node may be generated, and, in operation S120, the deepest node may be generated. Operation S115 may include registering at least one of network nodes corresponding to at least one routing depth.

In operation S125, a non-registered node may be detected by the deepest node. The deepest node is a node, the routing depth of which corresponds to the maximum depth of the sensor network. That is, the deepest node in the main cluster is a node that does not have a child node.

If a non-registered node is detected, a detection node (deepest node having detected the non-registered node) may generate a cluster request. For example, the cluster request may include the number of the detected non-registered nodes. For example, the cluster request may further include the quality of communication with the detected non-registered node. The detection node may transmit the cluster request. In operation S130, the cluster request may be delivered to the coordinator node CO via the intermediate node (in operation S125).

In operation S135, the coordinator node CO may assign the cluster address. For example, the coordinator node CO may select a free address from the cluster addresses according to m-bit cluster address. Then, the coordinator node CO may assign the selected free cluster address to a detection node. In operation S150, A cluster response including the assigned cluster address may be delivered to the detection node via the intermediate node (in operation S140). In operation S145, the intermediate node on the path through which the cluster response is transmitted may store the cluster address of the cluster response. In operation S155, based on the cluster response, the detection node may generate a sub cluster. Thereafter, the intermediate node routes a message targeting the sub cluster using the stored cluster address.

For example, when one non-registered node is detected by a plurality of deepest nodes, the coordinator node CO may receive a plurality of cluster requests. The coordinator node CO may select one of the detection nodes, based on the communication quality between the non-registered node and the detection node and the communication distance between the coordinator node CO and the detection node. A cluster response allowing the generation of a sub cluster may be delivered to the selected detection node. For example, a cluster response not allowing the generation of a sub cluster may be delivered to non-selected detection nodes.

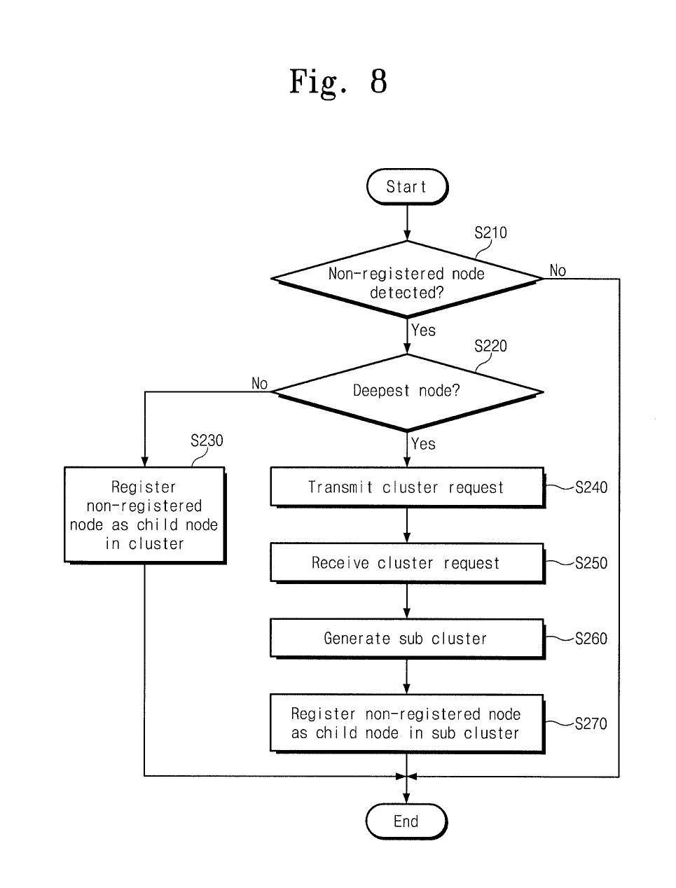

FIG. 8 is a flowchart illustrating an operation of a network node of the sensor network 30 described with reference to FIGS. 4 through 7. For example, an operation of a network node upon operation of forming the sensor network 30 or operation of extending (or updating) the sensor network 30 will be described.

Referring to FIG. 8, in operation S210, it is determined whether a non-registered node is detected. If a non-registered node is not detected, the operation of forming (or extending or updating) the network may end. That is, the network node may perform common communication or sensing.

If a non-registered node is detected, operation S220 may be performed. In operation S220, it is determined whether the network node is a deepest node. For example, the network node may compare the max depth Lm of the sensor network and its own routing depth. If the network node is not the deepest node, the network node may have a child node. In operation S230, the network node may register the non-registered node as its child node. For example, when the network node is a node in the main cluster, the non-registered node may be registered as a child node in the main cluster. When the network node is a node in the sub cluster, the non-registered node may be registered as a child node in the sub cluster.

If the network node is the deepest node, operation S240 may be performed. The deepest node can not have a child node. Accordingly, to register a non-register node, the network node may generate a cluster request. In operation S240, the network node may transmit a cluster request. As described with reference to FIGS. 6 and 7, the cluster request may be delivered to the coordinator node CO via an intermediate node. Based on the cluster request, the coordinator node CO may generate a cluster response. The cluster response may be delivered via the intermediate node. In operation S250, the network node may receive the cluster response.

In operation S260, based on the received cluster response, the network node may generate a sub cluster. For example, the topology (e.g., max depth Lm, max child Cm, and max router Rm) of the sub cluster may be equal to those of the main cluster. For example, the topology of the sub cluster may be different from the main cluster. The topologies of the sub clusters may be different from each other. The cluster response may include information on the topology of the sub cluster. Based on the topology information, the network node may generate a sub cluster.

In operation S270, the network node may register the non-registered node as a child node in the generated sub cluster.

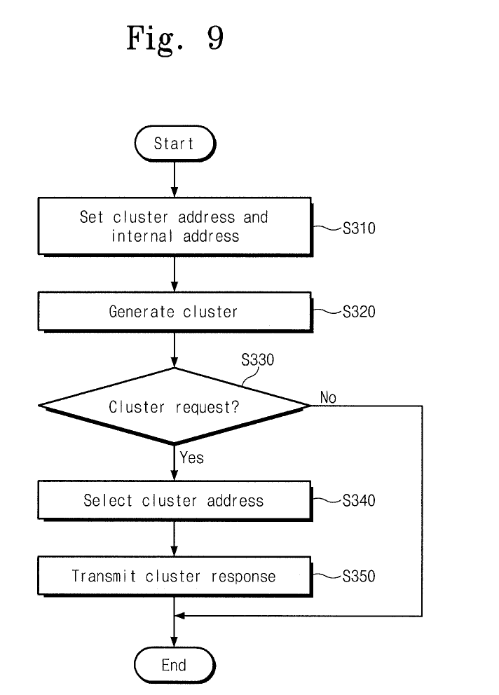

FIG. 9 is a flowchart illustrating an operation of a coordinator node CO of the sensor network 30 described with reference to FIGS. 4 through 7. For example, an operation of a network node upon operation of forming the sensor network 30 or operation of extending (or updating) the sensor network 30 will be described.

Referring to FIG. 9, in operation S310, the coordinator node CO may set cluster addresses and internal addresses. For example, the coordinator node CO may set a part of the addresses provided to the sensor network 30 to the cluster addresses, and may set the other part of the addresses to the internal addresses.

In operation S320, the coordinator node CO may generate a main cluster based on the set internal addresses. For example, the main cluster may be generated based on the max depth Lm, the max child CM, and the max router Rm. For example, the max depth Lm, the max child CM, and the max router Rm may be programmed by a user.

In operation S330, it is determined whether a cluster request is received. If the cluster request is not received, an operation of forming (or extending or updating) a network may end. That is, the coordinator node CO may perform common communication. If the cluster request is received, operation S340 may be performed.

In operation S340, the coordinator node CO may select a free address from the cluster addresses. Then, a cluster response including the selected free address may be generated.

In operation S350, the coordinator node may transmit the cluster response.

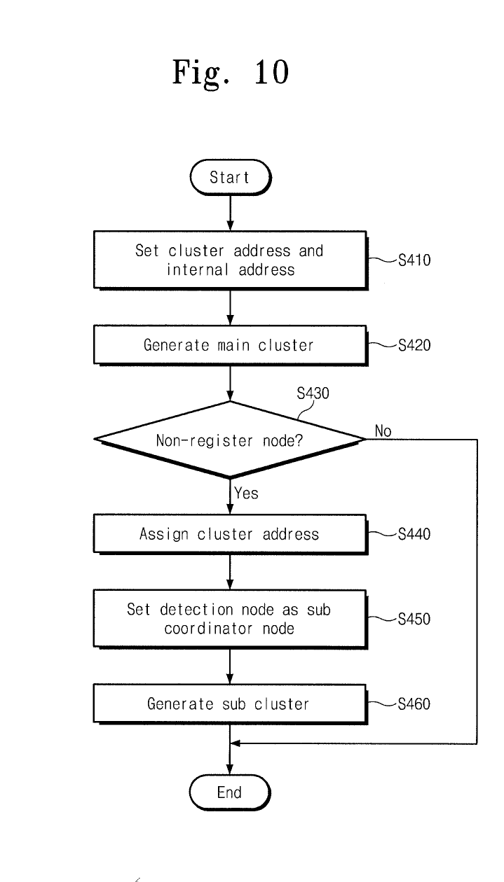

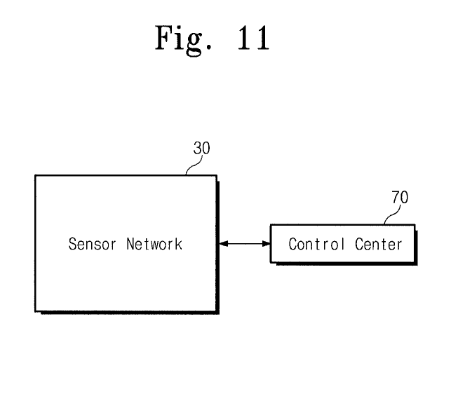

FIG. 10 is a flowchart illustrating a method for forming (or extending or updating) the sensor network 30 described with reference to FIGS. 4 through 7. Referring to FIG. 10, in operation S410, cluster addresses and internal addresses may be set. In operation S420, based on the set internal addresses, a main cluster may be generated. The main cluster may be generated based on the max depth Lm, the max child Cm, and the max router Rm. For example, the max depth Lm, the max child Cm, and the max router Rm may be programmed by a user.

In operation S430, it is determined whether a non-registered node is detected. For example, it is determined whether a non-registered node that can not be registered as a child node in a main cluster is detected. It is determined whether a non-registered node is detected by the deepest node of the main cluster. If a non-registered node is not detected, the procedure may end. That is, forming (or extending or updating) of the sensor network 30 may be completed. If a non-registered node is not detected, operation S440 may be performed.

In operation S440, a cluster address is assigned. In operation S450, a detection node having detected the non-registered node may be set as a sub coordinator. Thereafter, in operation S460, a sub cluster may be generated from the sub coordinator.

As described above, the sensor network 30 according to this embodiment may dynamically generate a sub cluster in response to the detection of the non-registered node. Accordingly, the number of wasted addresses can be minimized, and network scalability can be improved.

FIG. 11 is a diagram illustrating a sensor system including the sensor network 30 of FIG. 6 according to a first embodiment. Referring to FIG. 11, a sensor system may include a sensor network 30 and a control center 70. The sensor network 30, as described with reference to FIGS. 4 through 10, may generate a sub cluster dynamically when a non-registered node is detected.

The control center 70 may collect a sensing result from the sensor network 30. For example, based on the sensing result collected from the sensor network 30, the control center 70 may monitor a region corresponding to the sensor network 30 in real-time. Based on the sensing result collected from the sensor network 30, the control center 70 may monitor whether events such as criminals, disasters, accidents, and border disputes occur in the region corresponding to the sensor network 30. For example, based on the sensing result collected from the sensor network 30, the control center 70 may acquire information on weather, parking, and illumination controlling situations in the region corresponding to the sensor network 30.

For example, two or more sensor networks may be connected to the control center 70. The control center 70 may monitor the region corresponding to two or more sensor networks in real-time.

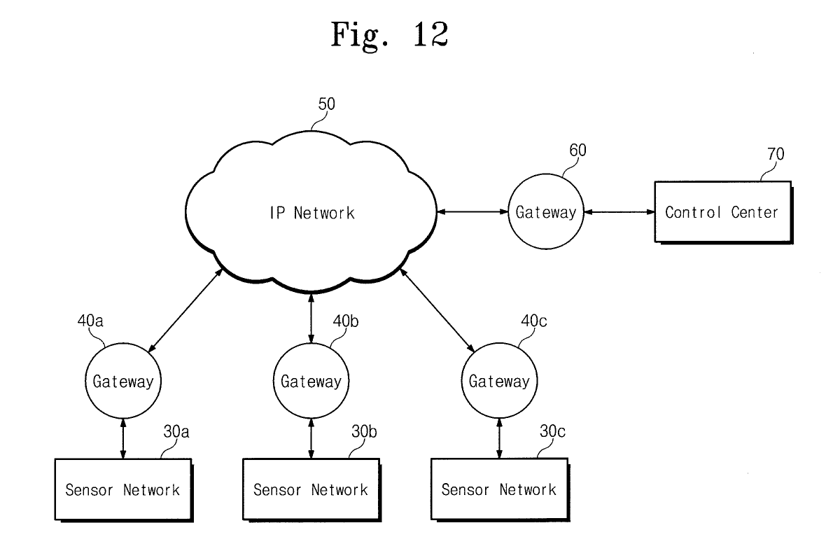

FIG. 12 is a diagram illustrating a sensor system including the sensor network 30 of FIG. 6 according to a second embodiment. Referring to FIG. 12, a sensor system may include a plurality of sensor networks 30a to 30c, a plurality of gateways 40a to 40c and 60, an Internet Protocol (IP) network 50, and a control center 70.

The respective sensor networks 30a to 30c may generate a sub cluster dynamically when a non-registered node is detected as described with reference to FIGS. 4 through 10. The sensor networks 30a to 30c may be connected to corresponding gateways 40a to 40c, respectively. The sensor networks 30a to 30c may be connected to the IP network 50 through the gateways 40a to 40c. The control center 70 may also be connected to the IP network 50 through the gateway 60.

The control center 70 may collect a sensing result from the sensor networks 30a to 30c. For example, the sensing result of the sensor networks 30a to 30c may be delivered to the IP network 50 through corresponding gateways 40a to 40c. In the IP network 50, the sensing result may be delivered to the gateway 50 connected to the control center 70. The control center 70 may receive the sensing result of the sensor networks 30a to 30c from the gateway 60.

Based on the sensing result collected from the sensor networks 30a to 30c, the control center 70 may monitor a region corresponding to the sensor networks 30a to 30c in real-time. For example, based on the sensing result collected from the sensor networks 30a to 30c, the control center 70 may monitor whether events such as criminals, disasters, accidents, and border disputes occur in the regions corresponding to the sensor networks 30a to 30c. For example, based on the sensing result collected from the sensor networks 30a to 30c, the control center 70 may acquire information on weather, parking, and illumination controlling situations in the regions corresponding to the sensor networks 30a to 30c.

Through the sensor networks 30a to 30 connected to the IP network, the control center 70 may perform wide area monitoring based on a plurality of sensor networks 30a to 30c. For example, the control center 70 may perform a real-time monitoring in regions corresponding to town, township, street, district, county, city, province, or country.

For example, the sensor networks 30a to 30c may be connected to the IP network 50 via a satellite. If the sensor networks 30a to 30c are connected to the IP network through a satellite, remote area monitoring can also be achieved on islands, mountain areas, oversea branches, and oversea public office.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method for operating a network node in a specific cluster of a tree-structured network based on distributed address assignment, the method comprising:
detecting a non-registered node;
determining a routing depth of the network node; and
generating a sub cluster using a cluster address and registering the detected non-registered node as a child node in the generated sub cluster using an internal address, when the determined routing depth corresponds to a reference value.

2. The method of claim 1, when the determined routing depth is smaller than the reference value, further comprising registering the detected non-registered node as a child node in the specific cluster using the internal address.

3. The method of claim 1, wherein the reference value corresponds to a maximum depth of the specific cluster.

4. The method of claim 1, further comprising operating as a sub coordinator corresponding to the generated sub cluster.

5. The method of claim 1, when the determined routing depth corresponds to the reference value, further comprising transmitting a cluster request corresponding to the detected non-registered node to a parent node.

6. The method of claim 5, when the determined routing depth corresponds to the reference value, further comprising receiving a cluster address according to the transmitted cluster request from the parent node.

7. A method for operating a coordinator node of a tree-structured network based on distributed address assignment, the method comprising:
dividing addresses assigned to the network into cluster addresses and internal addresses;
registering a child node using the internal addresses; and
selecting a free address from the cluster addresses and transmitting the selected free cluster address to the child node, when a cluster request is received.

8. The method of claim 7, further comprising setting a child node receiving the selected free cluster address to a routing path corresponding to the selected free cluster address.

9. A method for forming a tree-structured network based on distributed address assignment, the method comprising:
dividing addresses assigned to the network into cluster addresses and internal addresses;
generating a main cluster, based on the internal addresses; and
generating a sub cluster using the cluster addresses when a non-registered node is detected after generation of the main cluster.

10. The method of claim 9, further comprising registering the detected non-registered node in the generated sub cluster using the internal addresses.

11. The method of claim 9, further comprising generating a second sub cluster using on the cluster addresses when a second non-registered node is detected after generation of the generated sub cluster.

12. The method of claim 9, further comprising setting the network node having detected the non-registered node as a sub coordinator node of the generated sub cluster.

13. The method of claim 9, wherein the generating of the sub cluster using the cluster addresses comprises:
selecting a free address from the cluster addresses; and
assigning the selected free cluster address to the sub cluster.
